(19) United States
(12) Patent Application Publication
(10) Pub. No.: US 2013/0117646 A1
(43) Pub. Date: May 9, 2013

(54) SYSTEM AND METHOD FOR DELIVERING AND ACTIVATING A VIRTUAL GIFT CARD

(71) Applicants: Gregory Hansen, Twp. of Washington, NJ (US); Seth H. Sarelson, New York, NY (US); Johnathan A. Treiber, New York, NY (US)

(72) Inventors: Gregory Hansen, Twp. of Washington, NJ (US); Seth H. Sarelson, New York, NY (US); Johnathan A. Treiber, New York, NY (US)

(73) Assignee: REVTRAX, New York, NY (US)

(21) Appl. No.: 13/291,148

(22) Filed: Nov. 8, 2011

(51) Int. Cl. G06F 15/16; G06K 19/06; G06F 17/00

(52) U.S. Cl. 715/205; 709/217; 709/206; 235/494

(57) ABSTRACT

A system and method for delivering and activating a virtual gift card includes storing in a database at least one data item for use in creating a virtual gift card. A server creates a unique identifier for the virtual gift card and sends the unique identifier to the virtual gift card recipient. The unique identifier identifies a location for the recipient to retrieve the virtual gift card, but does not include the virtual gift card. In response to receiving a request from a recipient device to present the virtual gift card, the server generates the gift card, instructs a gift card processor to activate the gift card and transmits the virtual gift card to the recipient. The gift card may then be redeemed by the recipient at the corresponding merchant. The recipient thereby activates the gift card using a single action.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR COMPUTER PROGRAM LISTING COMPACT DISC APPENDIX

Not applicable.

### BACKGROUND OF THE INVENTION

The invention relates generally to the field of gift certificates. More particularly, the invention relates to the creation, distribution, activation and tracking of virtual gift cards.

Many retailers of goods and services offer gift certificates that may be used to purchase their goods or services. Historically, gift certificates have been sold by retailers in paper form having a dollar value printed or written on the piece of paper. More recently, gift certificates have been sold in the form of a gift card, that is a plastic card that may be used by the recipient to purchase goods from the retailer. The plastic gift card may identify the dollar value of the card on the card, or may encode the dollar value on a magnetic strip. These plastic gift cards often also include an alphanumeric code that may be used by the recipient to purchase goods over the phone or online.

These physical plastic gift cards have many drawbacks. First, the physical gift cards must be made and either shipped to the merchants' “brick and mortar” locations to be sold or shipped directly to the gift card recipient. Second, these plastic gift cards must also be pre-programmed with a monetary value or a monetary value must be encoded on the card at the point of sale. Further, if the gift card recipient loses the physical card, they typically cannot obtain a replacement card and the gift is lost.

Recently, merchants have been offering an alternative to physical gift cards—virtual gift cards. Virtual gift cards do not have a physical form, but rather are electronic in nature. Virtual gift cards have all the advantages of physical gift cards and may be sent electronically to recipients. Benefits of virtual gift cards include that they are not physically manufactured and do need to be physically delivered to the recipient. Similar to paper gift certificates and plastic gift cards, virtual gift cards typically have a monetary value associated with them and include a mechanism for the gift card issuer to recognize the gift card and the associated value. For example, virtual gift cards may have an alphanumeric identifier that the recipient provides either at the merchant's brick and mortar store or online to redeem the gift card. Virtual gift cards may also have a bar code into which the gift card's value is encoded. The virtual gift cards with bar codes may be read by standard bar code readers used at merchant locations.

Virtual gift cards may also be delivered to recipients through electronic means such as email, SMS and MMS messages. Electronic delivery saves the merchant shipping fees. Electronic delivery also alleviates the problem of the recipient losing the physical card.

Existing virtual gift cards still have many drawbacks. First, while most merchants are able to process the virtual gift cards when the recipient chooses to redeem the gift card online, some merchants have difficulty processing the virtual gift card when presented in the merchant's store. Second, many states have regulations governing how electronic payment information must be secured and consider virtual gift cards to be an electronic payment mechanism. For example, simply sending a code for a virtual gift card in the body of an email would violate many states' regulations. These regulations require that the gift card be encrypted in a manner such that the virtual gift card may only be decrypted by the intended recipient. Existing solutions for encrypting virtual gift cards require the recipient to perform many steps to gain access to the gift card. These series of steps are often cumbersome and frustrating for gift card recipients. Finally, it is difficult for merchants to track gift cards.

### BRIEF SUMMARY OF THE INVENTION

The invention relates generally to a method and system for delivering and activating a virtual gift card. The method includes storing in a database at least one data item for use in creating a virtual gift card. In one embodiment, the database is a secure database for storage of gift card images, gift card text, barcode(s) symbology, structure, and configuration settings for each gift card. The merchant issuing the gift card provides the information for the predetermined data fields so that each individual gift card may be identified. In one embodiment, the predetermined data fields include the merchant's name and how the gift card may be redeemed. In another embodiment, the merchant may also select a tracking method.

A server creates a unique identifier for the virtual gift card that identifies the data related to an individual gift card and provides the unique key to retrieve the gift card from the server. In one embodiment, the data includes the location (i.e. uniform resource locator) at which the recipient may retrieve the gift card. The server then transmits the unique identifier to the recipient. The unique identifier does not include the virtual gift card itself. In one embodiment the unique identifier is a hyperlink to a web page that is sent in an email to the recipient's email address or in a text message to the recipient's mobile device. In response to receiving a request from a recipient device to present the virtual gift card, the server dynamically generates the virtual gift card using the gift card information previously received from the merchant and stored in the database. In the embodiment in which the unique identifier is a hyperlink, the recipient invokes the hyperlink to request the gift card. The server also instructs a gift card processor to activate the virtual gift card. Once generated, the server transmits the virtual gift card to the recipient's device. By performing the single action of “clicking” on the URL provided by the server, the gift card is activated and electronically sent to the recipient.

In one embodiment, the step of dynamically generating the virtual gift card further comprises the step of generating a second unique identifier that identifies the virtual gift card. In various embodiments, the second unique identifier may be an alphanumeric code or a bar code that is capable of being read by a point of sale device at a store.

It is therefore an object of the present invention to provide a system and method whereby virtual gift cards can be securely distributed to the intended recipient. Another object of the invention is to provide a system which generates virtual gift cards that may be obtained by the intended recipient with a single action and not a complicated and burdensome series of steps. Yet another object of the invention is to provide a virtual gift card system in which issued virtual gift cards can be tracked.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a flowchart representation of an embodiment of a process for delivering and activating a virtual gift card according to the present invention;

FIG. 2 is a block diagram an embodiment of a system according to the present invention for delivering and activating a virtual gift card; and

FIG. 3 is a flowchart representation of an embodiment of a process for creating virtual gift cards having barcodes according to the present invention.

The attached drawings are intended to better illustrate the present invention without limiting it in any manner whatsoever. Like reference characters in the respective drawn figures indicate corresponding parts or steps.

### DETAILED DESCRIPTION OF THE INVENTION

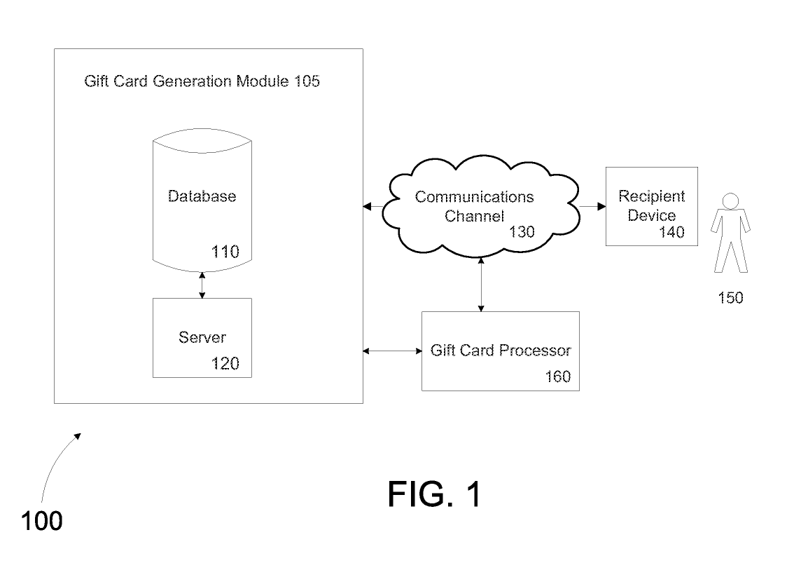

Referring to FIG. 1 and in brief overview, an embodiment of a system 100 for delivering a virtual gift card for a merchant is shown. The system 100 includes a gift card generation module 105, a communications channel 130, a recipient device 140 operated by a recipient 150, and a gift card processor 160. The gift card generation module 105 includes a database 110 and a server 120. In various embodiments, the merchant may be a retailer, a service provider such as a restaurant, a manufacturer, an advertising agency, or any other entity or person who may offer gift certificates for purchase. The merchant or other entity offering gift certificates may also be referred to herein as the “user”. The recipient of the virtual gift card may be an individual or any other entity to which the gift card sender desires to send a gift card. The recipient device 140 may a computer, a mobile phone, a personal digital assistant, a tablet, or any other electronic device through which the recipient 150 may receive or retrieve messages.

The database 110 stores a plurality of data items for use in creating the virtual gift card. The data fields are to be completed by the merchant or the merchant's agent to define the virtual gift card. The plurality of data items may be fields for the merchant to enter information, gift card creative such as image files, text files, sound files, video files or any combination of the foregoing. In one embodiment, the predetermined data fields include the merchant's name and how the gift card may be redeemed. The predetermined data fields may also include the validity dates of the gift card and participating store locations. The plurality of data items may also include a field for the value of the virtual gift card. The value of the virtual gift card is to be selected by the gift card sender. It should be understood, that the virtual gift card may also specify a particular good or service to which the recipient is entitled, rather than having a generic monetary value.

In one embodiment, the database 110 further includes a plurality of tracking methods that may be selected by the merchant to track the gift card. In one such embodiment, the database 110 is a secure database for storage of gift card images, gift card text, barcode(s) symbology, structure, and configuration settings for each gift card. In an another embodiment in which the gift card includes a bar code, the plurality of predetermined data fields includes selectable bar code structures. The merchant must provide inputs for a sufficient number predetermined data fields so that the gift card may be identified.

The communications channel 130 may be any channel through which the gift card generation module 105 may communicate with gift card processor 160 and the consumer device 140. For example, the communications channel 130 may be a telephone network, a mobile telephone network, the Internet, or any other communications means, whether now known or later developed.

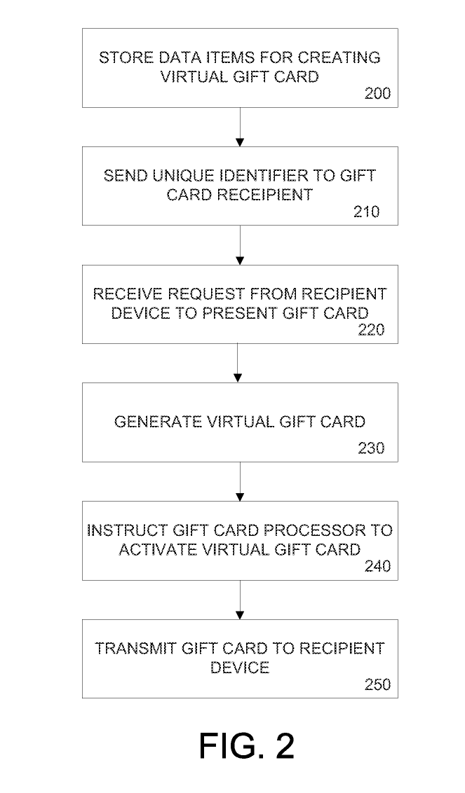

The operation of the system 100 will be described in more detail using the flowchart of FIG. 2. In step 200, the merchant stores the data items for use in creating the virtual gift card. Next in step 210, the server 120 generates a unique identifier for the virtual gift card and sends the unique identifier to the gift card recipient. The unique identifier is associated with the virtual gift card and identifies a location at which the recipient may retrieve the virtual gift card. In one embodiment, the unique identifier is a URL at which the recipient may retrieve the virtual gift card. It is important to note that the unique identifier does not include the virtual gift card itself, but rather is a way to retrieve and activate the gift card. In one embodiment, the unique identifier is sent in an email to the recipient's email account. In other embodiments, the unique identifier may be sent in a text message, such as a SMS or MMS message. In yet other embodiments, the unique identifier may be printed on a traditional paper gift certificate or plastic gift card. In one such embodiment, the unique identifier may be encoded in bar code such as a quick response (QR) code that may be read by a bar code reader or other device capable of interpreting a bar code. For example, many personal communications devices, such as mobile phones, may take a photograph of a bar code which is then interpreted by software running on the mobile device.

Next, in step 220, the server 120 receives a request from a recipient device 140 for the virtual gift card. In response to receiving a request from a recipient device 140 to present the virtual gift card, in step 230 the server 120 in communication with the database 110 dynamically generates the gift card using at least one the plurality of data items stored in the database 110 and in step 240 instructs the gift card processor 160 to activate the virtual gift card. As described above, the data items include the information previously received from the merchant and the gift card sender to be included in the virtual gift card. In one embodiment, the request to present the virtual gift card is sent from a browser operating on the recipient's device. In one such embodiment, the request is sent by the recipient invoking a hyperlink. In yet another embodiment, the request may be received via an email, SMS or text message, or any other method for communicating a request to the server. For example, in an embodiment in which the server 120 sent an email containing a hyperlink to the recipient device 140, the recipient 150 invokes the link, which in turn sends a request from the recipient device 140 to the server 120 to present the virtual gift card. The recipient has thereby activated and retrieved the virtual gift card by a single action of sending the request.

In an embodiment in which the unique identifier is printed on a traditional paper gift certificate or plastic gift card, the request to present the virtual gift card is sent from a browser operating on the recipient's device. In one such embodiment, the recipient enters the unique url provided on the paper or plastic gift card. In yet another embodiment, the request may be sent via an email, SMS or text message, or any other method for communicating a request to the server. In an embodiment in which the unique identifier is encoded in bar code such as a quick response (QR) code, the request is sent via a bar code reader or other device capable of interpreting a bar code. For example, a recipient may take a photograph of a QR code using their mobile device, which is then interpreted by software running on the mobile device and the request sent to the server.

In another embodiment, the server also generates a gift card identifier that may be used to identify the gift card. In one such embodiment, the gift card identifier may be included in the unique identifier that defines the location at which the gift card may be retrieved. The gift card identifier may be a bar code, a bar code capable of being read by a point of sale device at a store, an in-store promotional code or any other picture, text, sound, graphic or other identifying mechanism that may be used to identify the gift card. In an embodiment in which the server generates a bar code, the bar code conveys all the information required by the merchant to apply the gift card to a purchase and is in a format recognized by the merchant's equipment.

Once generated, in step 250 the server 120 transmits the virtual gift card to the recipient device 140. In one embodiment, the server 120 transmits the virtual gift card to the recipient device 140 through an electronic communication channel 130. In various embodiments, the virtual gift card can be represented to the recipient in the form of a printable gift card, a gift card code, a SMS/MMS /text message/email to the recipient's mobile phone with barcode, a SMS/MMS/text message/email to the recipient's mobile phone with a gift card code, etc. In the various embodiments, the gift card identifier may be contained in the barcode, in-store promotional code, or other applicable information per the respective delivery mechanism, but can identify information such as, but not limited to, gift card sender information, gift card recipient information or any other discretionary information the merchant desires to track. In another embodiment, the recipient's mobile device may include an application that is designed to store all of the recipient's virtual gift cards on the mobile device.

The recipient 150 may view, print, or perform another operation on the virtual gift card. As the gift card processor 160 has activated the virtual gift card, the recipient 150 may redeem the virtual gift card as indicated on the instructions on the gift card in step 240. For example, the recipient 150 may present the gift card at a location of the merchant, may place a call to the merchant to order an item/service, or may redeem the virtual gift card online at the merchant's web site. In one embodiment, the virtual gift card includes an alphanumeric code that the recipient may enter on the merchant's website in order to redeem the gift card.

In yet another embodiment, the virtual gift card sent to the recipient is capable of being redeemed using near field communication (NFC) technology. Many smartphones currently on the market already contain embedded NFC chips that can send encrypted data a short distance (“near field”) to a reader located, for instance, next to a retail cash register. Gift card recipients who have their virtual gift card information stored in their NFC smartphones can redeem the virtual gift card by waving their smartphones near or tapping them on the reader.

As described above, the merchant may also select a tracking method. In an embodiment of the system in which the merchant has selected a tracking method, the system tracks the virtual gift card upon the recipient accessing the gift card. In yet another embodiment in which the merchant selects a tracking method, the system tracks the virtual gift card upon the recipient selecting to print the gift card. In still another embodiment, the system uses the tracking method to track the gift card once the recipient redeems the gift card at a store, by phone or online. The tracking methods may include methods for tracking distribution channels, sender identification information and/or recipient identification information, or any other discretionary information the merchant desires to track.

In one embodiment, in order to track the promotion, the system includes identifying information in the gift card identifier. The identifying information may identify the method through which the gift card was distributed to the recipient, consumer identification information, or other information the merchant desires to track. For example, if the recipient requested the gift card to be presented by invoking a URL, the gift card identifier could identify the URL or a reference to the URL that the recipient invoked. The URL could then be tracked in the gift card. In another embodiment, the gift card identifier could identify the IP address of the recipient's device or a reference to the IP address of the recipient's device. The IP address of the recipient's device could then be tracked in the gift card. In still another embodiment, the email address or other mechanism used to contact the recipient can be tracked. The recipient information may be tracked back to the recipient by the system, or it may be tracked back to the recipient by a separate system maintained by the merchant. In yet another embodiment, the system stores the tracking information and the information that may be later matched with the tracking system is included in the gift card identifier. For example, the system may include the number 123 in the gift card identifier, and the system may associate the number 123 with a specific recipient. When the gift card with the number 123 in the gift card identifier is redeemed, the system will determine that the number 123 is associated with the recipient and will determine that the specific recipient redeemed the gift card. In other embodiments, the recipient information may be tracked back to the recipient by the system, or it may be tracked back to the recipient by a separate system maintained by the merchant. For example, the system may share with the merchant that the number 123 was assigned to a specific recipient and then the merchant or merchant's system may track the specific recipient that redeemed the gift card.

In yet other embodiments, virtual gift cards can be configured with fraud protection features that are based on rules specified by the merchant. In one such embodiment, fraud protection can be turned off or used to control how many times a virtual gift card is printed, and/or if the gift card can be forwarded to a different recipient. In certain embodiments, each fraud protection feature can be adjusted in real time and reset in real time.

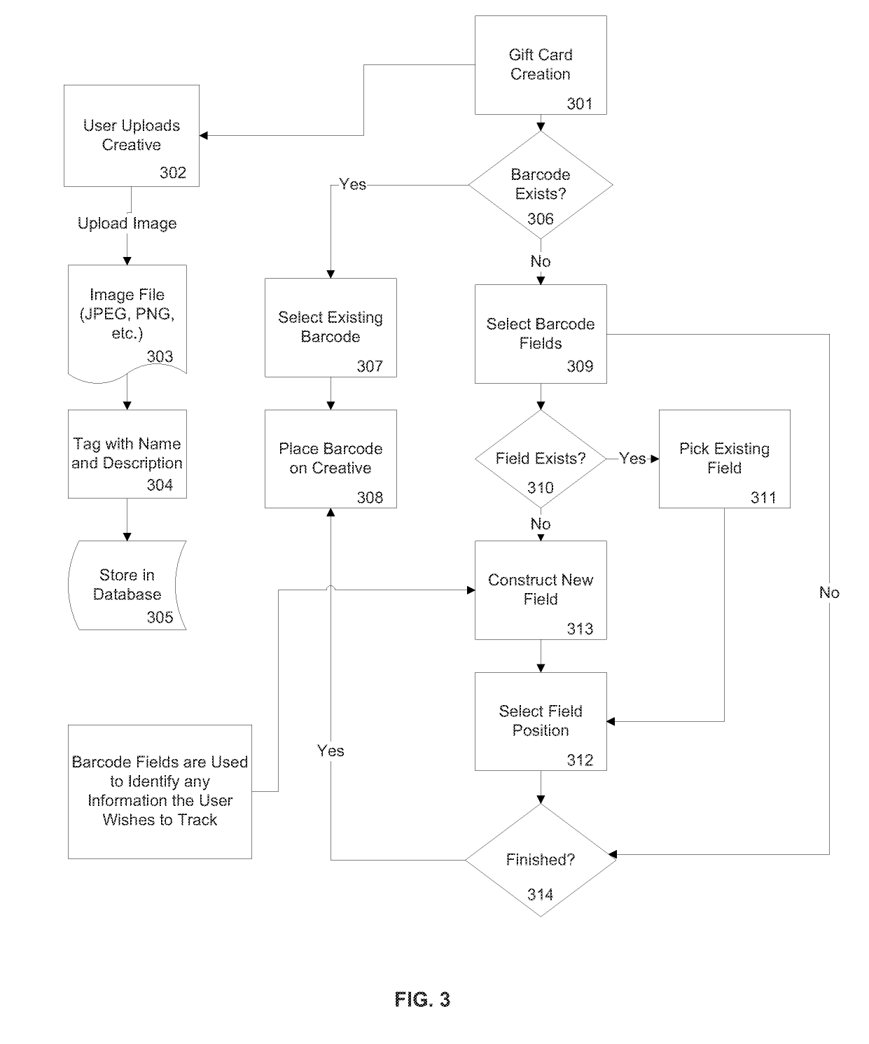

Referring to FIG. 3, an embodiment of a method for merchants to create virtual gift cards is shown. In one embodiment, the system provides for the creation, delivery and activation of virtual gift cards through a user interface that is accessible to the merchant (also referred to herein as “user”) via a secure login. In step 301, the retailer or other entity offering virtual gift cards creates their gift card. As described above, the retailer or other entity offering a gift cards for purchase may also be referred to herein as the “user”. Next in step 302, the user uploads a gift card creative. The gift card creative may include the “look and feel” of the gift card that the recipient views. The gift card creative may be an image file, text file, sound file, video file or any combination of the foregoing. Users can upload any gift card creative of their choice. The gift card creative can also be used for other uses, such as store promotions, if desired. In the example shown in the flowchart of FIG. 3, the gift card creative is an image file such as a JPG, PNG, or any other type of image file. In step 303, the image file is received by the gift card server 120, which in turn tags the image file with a name and description in step 304 and then stores the file in a creative library or database in step 305. By storing the gift card creative, the creative is available for other uses, such as in-store promotions. The dimensions and layouts of the gift card creative may be selected by the user.

Once the gift card creative has been uploaded, in one embodiment, the user may select to include a barcode(s) (and the position of the barcode(s)) and dynamic text (optional) or logos. The dynamic gift card text can be specified at run-time through the distribution channel or can be calculated text. The dynamic text can be provided either at run time or through predetermined fields such as “amount”. Other dynamic text may include the date of issuance of the virtual gift card. In yet other embodiments, the user may provide high level information of the gift card such as redemption information.

An an embodiment in which the user (retailer) desires to include a barcode, the process of creating a new barcode includes choosing the appropriate fields in length and position to capture the desired information. In one such embodiment, the barcodes include fields for both point-of-sale usage as well as for capturing data. Additional bar code fields can be created to capture data not previously captured. Referring again to FIG. 3, in an embodiment in which the user desires to include a barcode, in step 306 the user determines if the desired barcode structure for the gift card exists in the system. If a desired barcode layout exists already in the system, it may be chosen from the list of existing barcode layouts. If not, the user may create a new barcode layout, which is then stored as a library element in the user's account for use in the future. If the desired barcode structure exists, the user may select it for the gift card in step 307 and place it on or associate it with the creative in step 308. The user may also select the position of the barcode. In one embodiment, barcodes are overlaid on the gift card upon creation at runtime and can be positioned anywhere on the gift card.

If the desired barcode structure does not exist in the system, in step 309 the user creates a new barcode by selecting from available barcode fields. If the user determines that the desired field exists in step 310, the user can select the existing field in step 311 and then in step 312 select the position for the field within the barcode structure. If the user determines that the desired field does not exist in step 310, the user can construct a new field in step 313 and then proceed to step 312 and select a position for the field within the barcode structure. Fields can also be created to capture information not previously available. There is no limit to the information that can be captured in a barcode.

If in step 314, the user determines that the barcode is not complete, the user returns to step 309, selects additional barcode fields and repeats the process. This process of choosing and/or creating barcode fields continues until enough fields are in the barcode to both identify the gift card at the point of sale (“POS”) and capture the desired information. If in step 314 the user determines that the barcode is complete, the process returns to step 308 and the barcode is placed on or associated with the creative.

As described above, the virtual gift card may be accessed via a computer, mobile phone, or other device. If the gift card is accessed via a computer, in one embodiment, the computer's internet browser requests the promotion from the secure system, which then uses an algorithm to create the barcode/gift card code utilizing pre-determined fields and validates the request against any security/fraud protection rules. If the request fails the check against the security/fraud protection rules, the recipient sees an error code/image. If the request passes the check against the security/fraud protection rules, the virtual gift card is sent back to the recipient's internet browser and the recipient is able to redeem the virtual gift card.

If the gift card is accessed via a mobile phone, the mobile phone requests the promotion from the secure system, which then uses an algorithm to create the barcode/promo code utilizing pre-determined fields and validates the request against any security/fraud protection rules. If the request fails the check against the security/fraud protection rules, the recipient sees an error code/image. If the request passes the check against the security/fraud protection rules, the virtual gift card is sent back to the recipient's mobile phone. The recipient may open gift card in any web browser. All fraud protection elements of the gift card are run and checked against the available data. The recipient can print the virtual gift card on any printer capable of printing graphics or utilize the image on a mobile phone.

In one embodiment including barcodes in the gift card, the barcodes are generated in real time utilizing all available data. The request to deliver a gift card and/or a barcode and each field in the barcode is analyzed and the data is gathered. The data that covers all fields is run through an algorithm which ensures the length of the barcode and content matches the merchant's specifications. When the secure system receives a request for a gift card, the secure system utilizes an algorithm to create a barcode utilizing predetermined fields. The system then looks up the pre-determined length of the barcode. The system then creates at least one barcode field and checks if any barcode fields are left. If any barcode fields are left in step, the system matches a data input to the field and maps the data to the field, ensuring that the data fits the pre-determined field size. If any barcode fields are not left, the system looks up the predetermined symbology of the barcode, then maps the fields to an alphanumeric sequence and generates a graphical barcode as an output.

As described above in the discussion of FIG. 3, the barcode fields that are used to capture data can be chosen from a library of fields. Fields can be created at the discretion of the merchant to satisfy the merchant's data capture requirements. The field lengths and the field positions may be at the discretion of the merchant. The barcode symbology may also be chosen by the merchant. For example, the merchant may select from: UPC, Code 128, EAN, GS1 Databar, QR Codes, and other type of barcode symbologies. Each of the data fields are mapped to available data that is provided to the system at runtime.

While we have discussed the use of the invention to create virtual gift cards, it should be understood that these concepts, methods and processes can be used in many analogous situations. For example, the system and method described above could be used to deliver merchant promotions, coupons, virtual credit cards, virtual debit cards, virtual traveler's cheques and any other virtual payment vehicle or other item that needs to be delivered securely and only activated by the intended user. Also as described above, the invention may be used to activate gift cards from non-digital sources, such as traditional paper gift certificates or plastic gift cards. In this embodiment, the gift card recipient has received a non-digital gift card that must be activated before it can be redeemed.

Having described various embodiments of the invention, it will now become apparent to one of ordinary skill in the art that other embodiments incorporating the concepts may be used. Specifically, any combination or all of the techniques described above may be incorporated by a system for delivering and activating virtual gift cards. For example, a single system may include a tracking technique and a fraud prevention technique. It is felt, therefore, that these embodiments should not be limited to the disclosed embodiments, but rather should be limited only by the spirit and scope of the following claims.

What is claimed is:

1. A method for delivering a virtual gift card comprising the steps of:
storing in a database at least one data item for use in creating a virtual gift card;
sending by a server a first unique identifier relating to the virtual gift card and identifying a location to retrieve the virtual gift card to a recipient, wherein the first unique identifier does not include the virtual gift card; and
receiving at the server a request from a recipient device to present the virtual gift card.

2. The method of claim 1 further comprising the step of instructing, by the server, a gift card processor to activate the virtual gift card.

3. The method of claim 2 further comprising the steps of:
dynamically generating by the server the virtual gift card using the at least one data item; and
transmitting the virtual gift card from the server to the recipient device.

4. The method of claim 2 wherein the first unique identifier is a hyperlink to a web page and wherein the server receives the request in response to the recipient invoking the hyperlink.

5. The method of claim 4 wherein the step of transmitting the virtual gift card further comprises transmitting the virtual gift card from the server to a browser executing on the recipient device.

6. The method of claim 3 wherein the step of dynamically generating the virtual gift card further comprises the step of generating a second unique identifier that identifies the virtual gift card.

7. The method of claim 6 wherein the step of generating the second unique identifier further comprises the step of generating a bar code.

8. The method of claim 7 wherein the bar code is capable of being read by a point of sale device at a store.

9. The method of claim 1 wherein the recipient device is a mobile communication device.

10. The method of claim 3 further comprising the step of storing in the database at least one tracking method for use in creating the virtual gift card, and wherein the step of dynamically generating the virtual gift card includes using the at least one tracking method.

11. The method of claim 10 further comprising the step of the server using the at least one tracking method to track the virtual gift card upon the recipient accessing the virtual gift card.

12. The method of claim 10 further comprising the step of the server using the at least one tracking method to track the virtual gift card upon the recipient redeeming the virtual gift card.

13. The method of claim 1 wherein the step of sending the first unique identifier further comprises sending an email including the first unique identifier.

14. The method of claim 1 wherein the step of sending the first unique identifier further comprises sending a text message including the first unique identifier.

15. A system for delivering a virtual gift card comprising:
a database storing at least one data item for use in creating a virtual gift card; and
a server in communication with the database, wherein the server (1) sends a first unique identifier relating to the virtual gift card and identifying a location to retrieve the virtual gift card to a recipient; and (2) receives a request from a recipient device to present the virtual gift card.

16. The system of claim 15 wherein the server (3) instructs a gift card processor to activate the virtual gift card.

17. The system of claim 16 wherein the server (4) dynamically generates the virtual gift card using the at least one data item; and (5) transmits the virtual gift card from the server to the recipient device.

18. The system of claim 15 wherein the first unique identifier is a hyperlink to a web page and wherein the server receives the request in response to the recipient invoking the hyperlink.

19. The system of claim 17 wherein the server transmits the virtual gift card to a browser executing on the recipient device.

20. The system of claim 17 wherein the server generates a second unique identifier in generating the virtual gift card.

21. The system of claim 20 wherein the second unique identifier is a bar code.

22. The system of claim 21 wherein the bar code is capable of being read by a point of sale device at a store.

23. The system of claim 15 wherein the recipient device is a mobile communication device.

24. The system of claim 17 wherein the database stores at least one tracking method for use in creating the virtual gift card, and wherein server uses the at least one tracking method in generating the virtual gift card.

25. The system of claim 24 wherein the server uses the at least one tracking method to track the virtual gift card upon the recipient accessing the virtual gift card.

26. The system of claim 24 wherein the server uses the at least one tracking method to track the virtual gift card upon the recipient redeeming at least a portion of the virtual gift card.

27. The system of claim 17 wherein the servers sends the first unique identifier by sending an email including the first unique identifier.

28. The system of claim 17 wherein the server sends the first unique identifier by sending a text message including the first unique identifier.

29. A system for delivering virtual gift card to a recipient comprising:
a database storing a plurality of predetermined data fields for use in creating a virtual gift card; and
a server in communication with the database, the server receiving inputs for the plurality of predetermined data fields from a user;
wherein the server (i) sends a first unique identifier relating to the virtual gift card and identifying a location to retrieve the virtual gift card to a recipient; (ii) dynamically generates the virtual gift card using the inputs in response to receiving a request from a recipient device to present the virtual gift card; (iii) instructs a gift card processor to activate the virtual gift card; and (ii) transmits the virtual gift card to the recipient device after generation.
